(19) United States
(12) Patent Application Publication
(10) Pub. No.: US 2017/0360190 A1
(43) Pub. Date: Dec. 21, 2017

(54) Height Adjustable Table

(71) Applicants: BenQ CO., LTD., Shanghai (CN); BenQ Corporation, Taipei (TW)

(72) Inventor: WEI-CHIEH CHEN, Taoyuan (TW)

(21) Appl. No.: 15/622,063

(22) Filed: Jun. 13, 2017

(30) Foreign Application Priority Data
Jun. 17, 2016 (CN) 201610431157.9

(51) Int. Cl. A47B 9/20; A47B 21/02; F16L 3/01; A47B 17/02; A47B 9/00

(52) U.S. Cl. CPC A47B 9/20; A47B 21/02; A47B 9/00; A47B 17/02; F16L 3/01

(57) ABSTRACT

A height adjustable table includes a table and at least a baffle. The table includes a height adjustable tabletop capable of being lifted up and down in a predetermined direction. The at least a baffle is disposed at least a side of the height adjustable tabletop. Each baffle extends upward and/or downward from the height adjustable tabletop. Because of the baffle, the height adjustable table has an anti-pinch function.

### TECHNICAL FIELD

The present invention relates generally to a table, and more particularly relates to a height adjustable table.

### BACKGROUND OF THE INVENTION

In recent years, the gaming industry has grown significantly in terms of annual output value, and the number of players is also rising rapidly. Therefore, the gaming industry has gained more and more attention.

Furthermore, by connections via the Internet, online games are free from geographical and national boundaries, and thus attract players from different countries to invest and gather in online gaming platforms. At the same time, for promotion of gaming competition, domestic and foreign industries also compete to organize world-class competitions. For such purpose, many domestic and foreign industries set up exclusive gaming teams to battle in gaming competitions.

E-competition venues usually include tables that are arranged side by side. In order to adapt to heights or other habits of the contestants, some of the competition tables may be equipped with height-adjustable desktops, so that participants may adjust the desktop heights according to their own needs. However, since the competition tables are arranged side by side, when adjusting the height of the table, the player's hand or other part of the body or any article on the table may be pinched if it is placed beyond the range of the desktop. Taiwan Patent No. TW M288136 discloses a height adjusting device for a desktop. Taiwan Patent No. TW M373156 discloses a retractable table having reinforced structures. None of the prior arts, alone or in combination, provide enough teachings for solving the above-mentioned problems.

### SUMMARY OF THE INVENTION

The present invention provides a height adjustable table having an anti-pinch function.

For achieving the above-mentioned advantage, the invention provides a height adjustable table includes a table and at least a baffle. The table includes a height adjustable tabletop, wherein the height adjustable tabletop is adapted to be moved up and down in a predetermined direction. The at least a baffle is disposed on at least a side of the height adjustable tabletop, wherein each of the baffle extends upward and/or downward from the height adjustable tabletop, and each of the baffle comprises a maximum height along the predetermined direction no less than a maximum travel length of the height adjustable tabletop.

In an embodiment of the invention, each of the baffle extends downward from the height adjustable tabletop.

In an embodiment of the invention, the above-mentioned height adjustable table further includes at least a structural reinforcement member, and each of the structural reinforcement member is disposed at a side of each of the baffle away from the table.

In an embodiment of the invention, each of the above-mentioned structural reinforcement members extends along the predetermined direction and is strip shaped.

In an embodiment of the invention, each of the baffle and the correlated structural reinforcement member disposed thereon are integrally formed.

In an embodiment of the invention, the above-mentioned height adjustable tabletop includes a first side and a second side opposite to each other, and a third side connected between the first side and the second side, wherein the third side is adjacent to the user, and at least one of the baffles is disposed on the first side and/or the second side.

In an embodiment of the invention, the above-mentioned table further includes a plurality of height adjustable table legs supporting the height adjustable tabletop, so as to enable the height adjustable tabletop to move up and down.

In an embodiment of the invention, the above-mentioned baffles are made of metal or plastic.

In an embodiment of the invention, each of the baffle extends upward from the height adjustable tabletop, and each of the baffle has a maximum height along the predetermined direction no less than a maximum travel length of the height adjustable tabletop.

In an embodiment of the invention, a portion of each of the baffle extends downward from the height adjustable tabletop; another portion of each of the baffle extends upward from the height adjustable tabletop, and each of the baffle has a maximum height along the predetermined direction no less than a maximum travel length of the height adjustable tabletop.

The height adjustable table of the invention provides a plurality of baffles disposed on the sides of the height adjustable tabletop, and thus prevents the user's hand or other portion of the body abutted against the height adjustable tabletop, or any object placed on the height adjustable tabletop, from being pinched during the lifting operation of the height adjustable tabletop, even when there are several height adjustable tables of the invention arranged side by side.

### BRIEF DESCRIPTION OF THE DRAWINGS

The present invention will become more readily apparent to those ordinarily skilled in the art after reviewing the following detailed description and accompanying drawings, in which:

FIG. 1 is a schematic view of a height adjustable table according to an embodiment of the invention.

FIG. 2 is a schematic view illustrating two adjacent height adjustable tables of FIG. 1.

FIG. 3 is a schematic view of a height adjustable table according to another embodiment of the invention.

FIG. 4 is a schematic view illustrating two adjacent height adjustable tables of FIG. 3.

FIG. 5 is a schematic view illustrating two adjacent height adjustable tables according to still another embodiment of the invention.

FIG. 6 is a schematic view of a height adjustable table according to yet another embodiment of the invention

FIG. 7 is a top view illustrating two adjacent height adjustable tables of FIG. 6.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

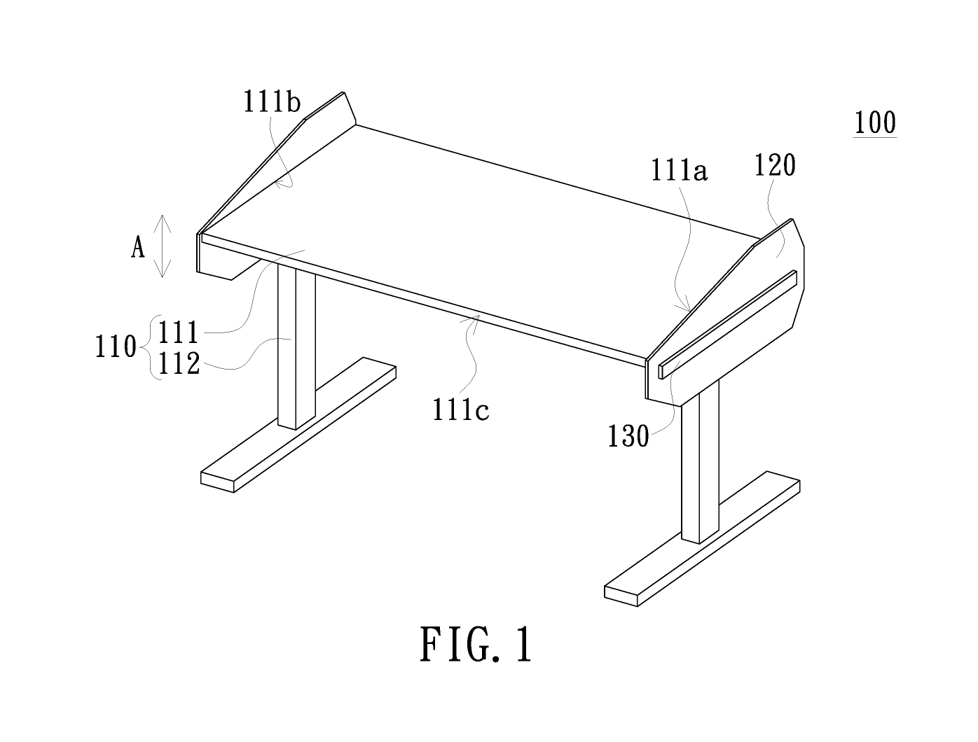

FIG. 1 is a schematic view of a height adjustable table according to an embodiment of the invention. Referring to FIG. 1, the height adjustable table 100 according to the embodiment includes a table 110 and at least a baffle 120. The table 110 includes a height adjustable tabletop 111, which is adapted to be moved up and down along a predetermined direction A. In detail, the table 110, for example, further includes a plurality of height adjustable table legs 112 for supporting the height adjustable tabletop 111, so as to enable the height adjustable tabletop 111 to move up and down along the predetermined direction A. Furthermore, the height adjustable tabletop 111, for example, includes the first side 111a and the second side 111b opposite to each other, and a third side 111c connecting between the first side 111a and the second side 111b, wherein the third side 111c is adjacent to the user. The at least one baffle 120 is disposed on at least a side of the height adjustable tabletop 111. For example, the at least a baffle 120 may be disposed on the first side 111a and/or the second side 111b. Taking an example as shown in FIG. 1, there are two baffles 120 respectively disposed on the first side 111a and the second side 111b.

The baffle 120, for example, extends upward and/or downward from the height adjustable tabletop 111. The baffle 120 may but not limited to be made of metal or plastic. Furthermore, the baffles 120, for example, are slice shaped. The height adjustable table 100 may further include at least a structural reinforcement member 130, and each of the structural reinforcement member 130 is disposed on the side of the baffle 120 away from the table 110, so as to reinforce the structure of the baffle 120. In an embodiment, each of the baffle 120 is integrally formed with the associated structural reinforcement member 130. Furthermore, there may be one or more structural reinforcement members 130 disposed on each of the baffle 120.

In the invention, the height adjustable table 100 includes two baffles 120 disposed on the first side 111a and the second side 111b of the height adjustable tabletop 111. The baffles 120 includes portions extend upward form the height adjustable tabletop 111, and thus may keeps the hand or other portion of the user abutting against the height adjustable tabletop 111, or any article placed on the height adjustable tabletop 111 within the first side 111a and the second side 111b. Therefore, even if there is another height adjustable table adjacent to the first side 111a and the second side 111b, when lifting the height adjustable tabletop 111, the hand or other portion of the user abutting against the height adjustable tabletop 111, or any article placed on the height adjustable tabletop 111 may be kept from being pinched by the adjacent tables.

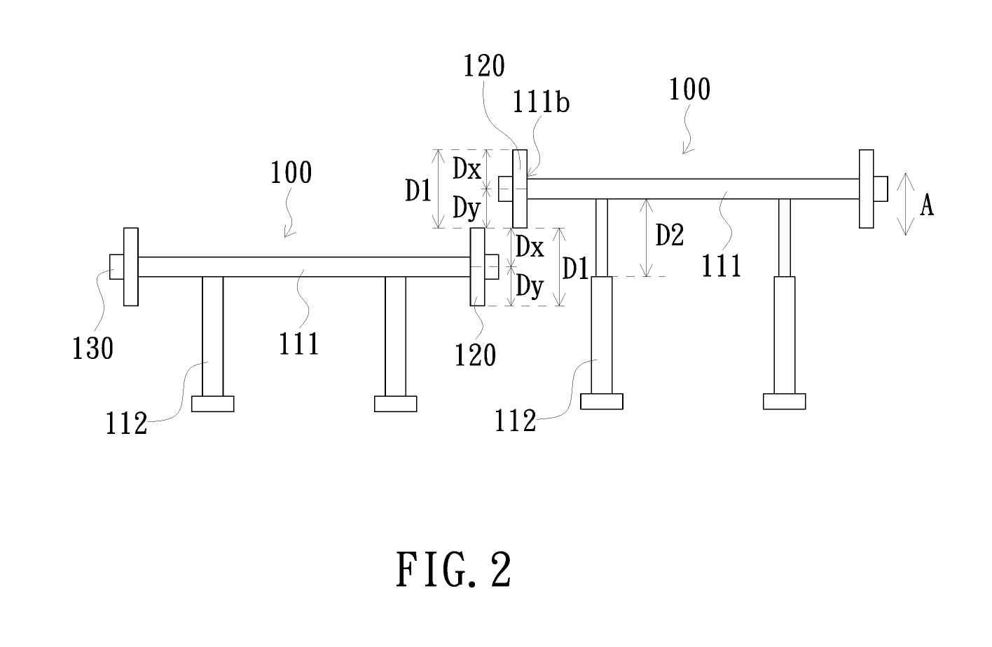

FIG. 2 is a schematic view illustrating two adjacent height adjustable tables of FIG. 1. The height adjustable table legs 112 of the height adjustable table 100 shown in the left portion of FIG. 2 are retracted as a shortest state, so as to keep the height adjustable tabletop 111 at a lowest position, and the height adjustable table legs 112 of the height adjustable table 100 shown in the right portion of FIG. 2 are extracted to a longest state, so as to keep the height adjustable tabletop 111 at a highest position. In this embodiment, the maximum height D1 of each of the baffle 120 along the predetermined direction A (i.e. the lifting direction of the height adjustable tabletop 111) may be designed as no less than the maximum travel length D2 of the lifting operation of the height adjustable tabletop 111. Taking an example as shown in FIG. 2, the maximum height D1 equals to the height Dx of the baffle 120 extending upward from the center of the thickness direction of the height adjustable tabletop 111, plus the height Dy of the baffle 120 extending downward from the center of the thickness direction of the height adjustable tabletop 111. Wherein, the maximum height D1, for example, equals to the maximum travel length D2. When the height adjustable tabletop 111 in the left side is in the lowest position and the height adjustable tabletop 111 of the right side is lifted to the highest position, the height difference between the left and right ones of the height adjustable tabletops 111 equals to the maximum travel length D2. Furthermore, since the maximum height D1 equals to the maximum travel length D2, the height Dx of the baffle 120 of the left one of the height adjustable tabletops 111 extending upward may be aligned to the height Dy of the baffle 120 of the right one of the height adjustable tabletops 111 extending downward. Consequently, the upward extending portion of the baffle 120 on the right side of the left one of the height adjustable tabletops 111 may be followed by the downward extending portion of the baffle 120 on the left side of the right one of the height adjustable tabletops 111, and thus ensure that the hand or other portion of the user abutting against the height adjustable tabletop 111, or any article placed on the height adjustable tabletop 111 may not cross over to the underneath of the adjacent height adjustable tabletop 111, and thus the risk of being pinched is reduced.

The number of the baffle 120 of the height adjustable table 100 shown in FIG. 1 may be adjusted according to different needs. For example, if the other height adjustable table is only disposed on the first side 111a and there is no other height adjustable table disposed on the second side 111b of the height adjustable tabletop 111, there would be no need to dispose the baffle 120 on the second side 111b, and only the first side 111a is installed with the baffle 120.

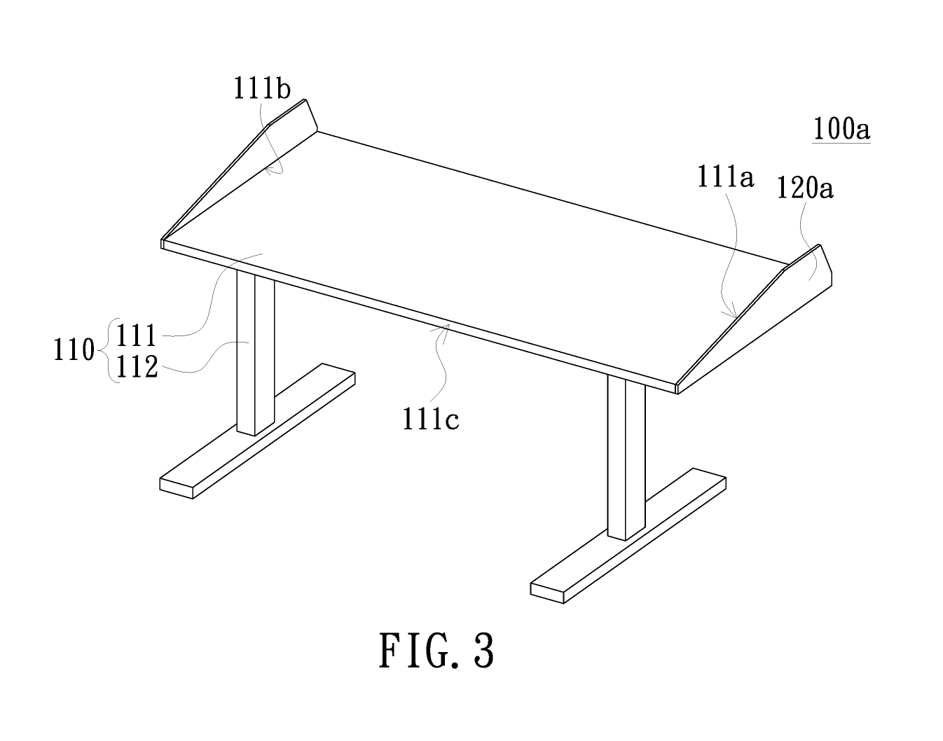

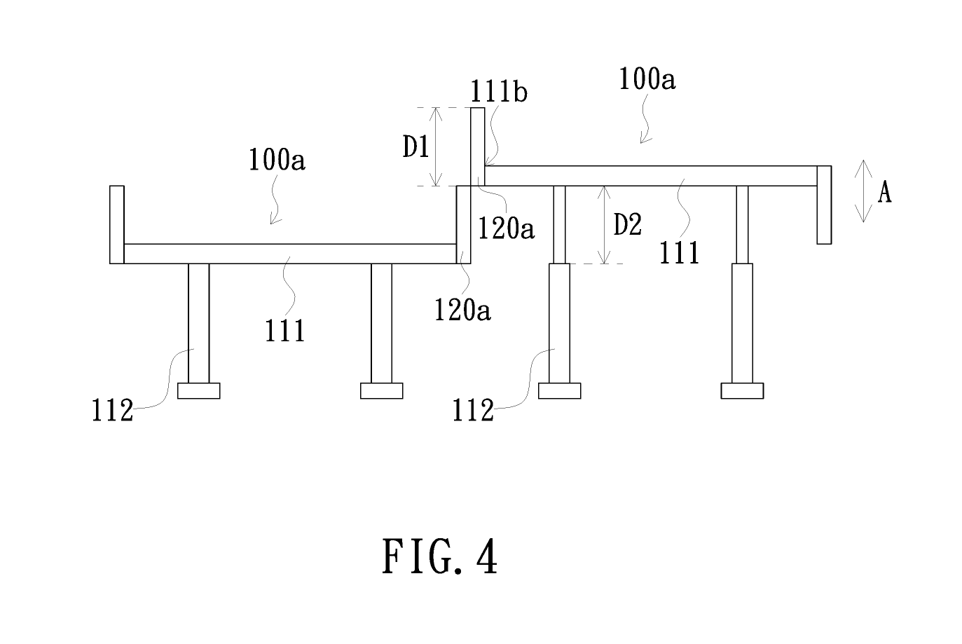

The baffle 120 shown in FIG. 1 extends not only upward from the height adjustable tabletop 111 but also downward from the height adjustable tabletop 111. However, in the other embodiment shown in FIG. 3, the baffles 120a of the height adjustable table 100a may only extend upward from the height adjustable tabletop 111, and do not extend downward from the height adjustable tabletop 111. The baffles 120a shown in FIG. 3 may also prevent the hand or other portion of the user abutting against the height adjustable tabletop 111 from crossing over the first side 111a and the second side 111b, and thus avoid the situation of being spinched during the lifting operation of the height adjustable tabletop 111. Moreover, as shown in FIG. 4, the maximum height D1 of each of the baffle 120 shown in FIG. 3 along the predetermined direction A (i.e. the lifting direction of the height adjustable tabletop 111) may be designed as no less than the maximum travel length D2 of the lifting operation of the height adjustable tabletop 111, so as to ensure that the hand or other portion of the user abutting against the height adjustable tabletop 111, or any article placed on the height adjustable tabletop 111 may not cross over to underneath of the adjacent height adjustable tabletop 111, and thus the risk of being pinched is reduced.

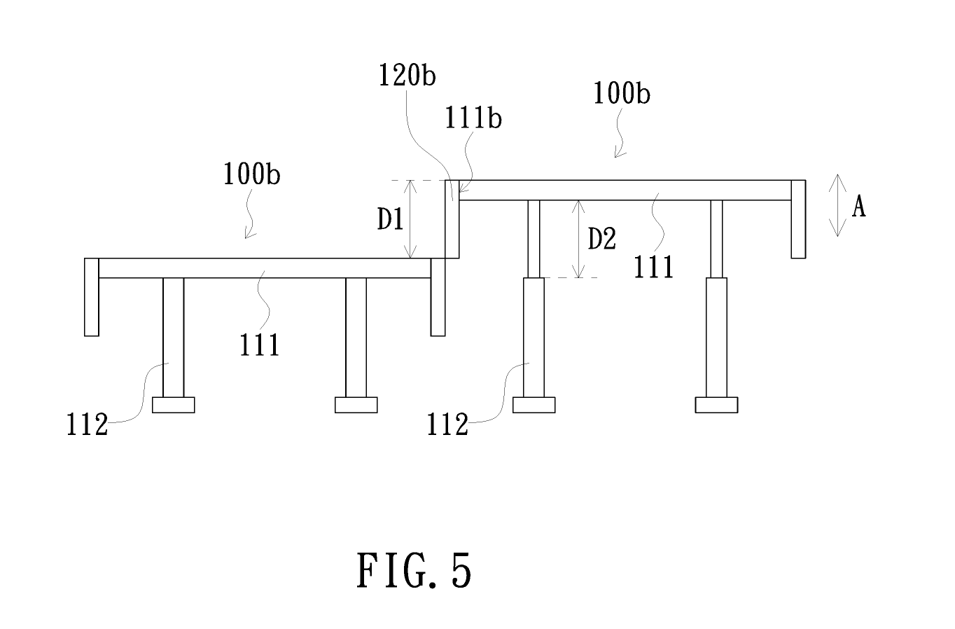

In the other embodiment, the baffles 120 may only extend downward from the height adjustable tabletop 111, and do not extend upward from the height adjustable tabletop 111. FIG. 5 is a schematic view illustrating two adjacent height adjustable tables according to another embodiment of the invention. Referring to FIG. 5, the height adjustable table legs 112 of the height adjustable table 100b are retracted as a shortest state, so as to keep the height adjustable tabletop 111 at a lowest position, and the height adjustable table legs 112 of the height adjustable table 100b are extracted to a longest state, so as to keep the height adjustable tabletop 111 at a highest position. The baffles 120b disposed on the sides of the height adjustable tabletop 111 only extend downward from the height adjustable tabletops 111, and do not have portions extending upward from the height adjustable tabletop 111. The maximum height D1 of each of the baffle 120b along the predetermined direction A (i.e. the lifting direction of the height adjustable tabletop 111) may be designed as no less than the maximum travel length D2 of the lifting operation of the height adjustable tabletop 111. Consequently, the hand or other portion of the user abutting against the height adjustable tabletop 111 may be limited by the adjacent one of the height adjustable tables 100b and thus being kept away from crossing over the range covered by the height adjustable tabletop 111 of the adjacent one of the height adjustable tables 100b. Therefore, during the lifting operation of the left one and/or the right one of the height adjustable tabletops 111, the hand or other portion of the user of the left one of the height adjustable table 100b abutting against the height adjustable tabletop 111, or any article left on the height adjustable tabletop 111 will not be pinched. Since the right one of the height adjustable tabletops 111 is higher than the left one, during the uplifting process of the left one of the height adjustable tabletops 111, and/or the downward moving process of the right one of the height adjustable tabletop 111, even if the user of the right one of the height adjustable tables 110b puts a hand or other portion against the height adjustable tabletop 111, or any article placed on the height adjustable tabletop 111 crosses over the right one of the height adjustable tabletops 111, it would be pushed upward by the left one of the height adjustable tabletops 111 at most, but the risk of being pinched is very low.

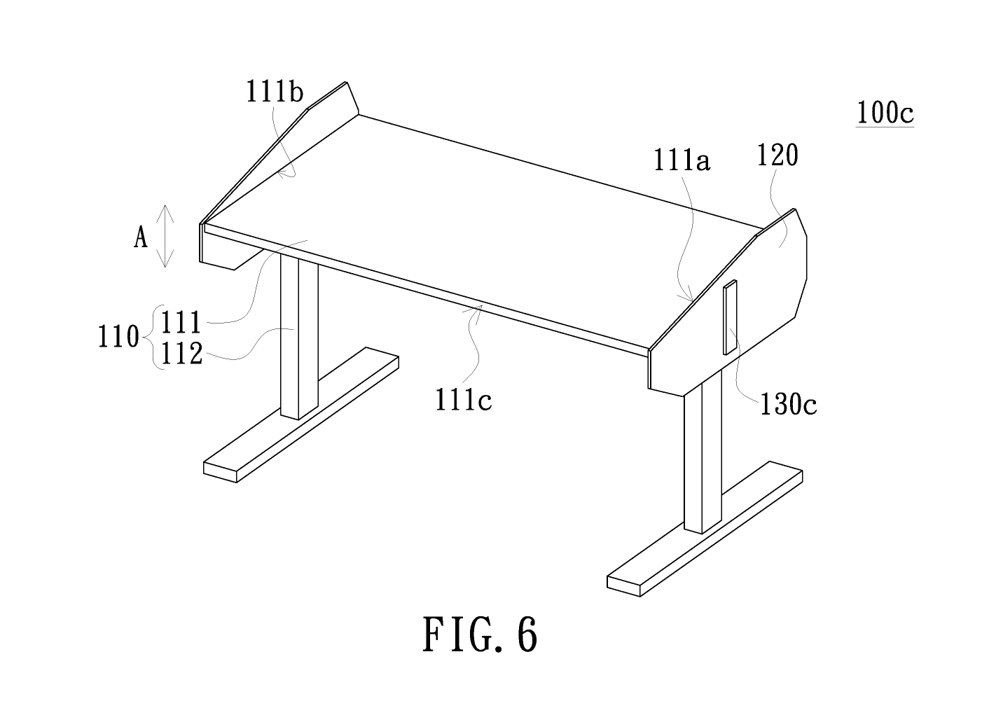

As shown in FIG. 1, the structural reinforcement member 130, for example, extends along the first side 111a and is strip shaped, but the invention does not limit the extending direction and shape of the structural reinforcement member 130. For example, in another embodiment, the structural reinforcement member may extend along the predetermined direction A and is strip shaped, as the structural reinforcement member 130c of the height adjustable table 100c shown in FIG. 6.

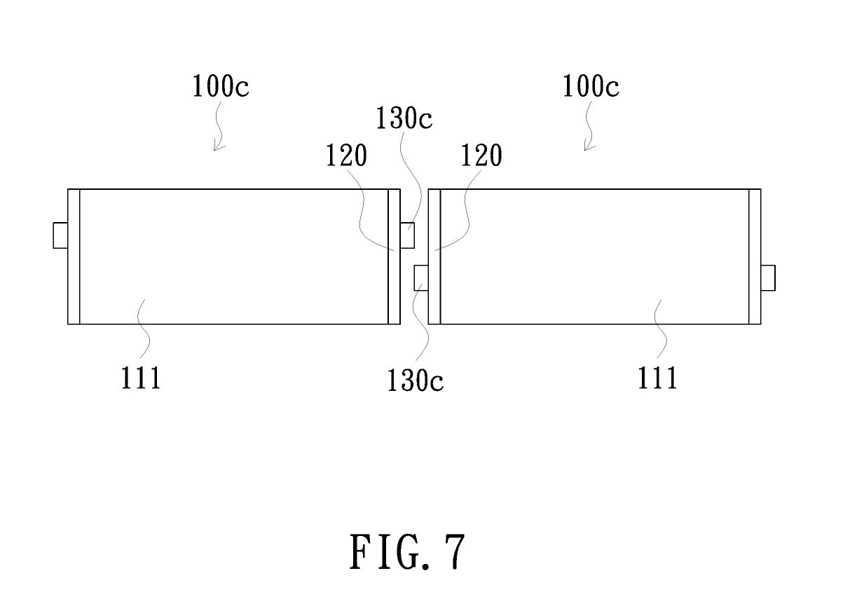

FIG. 7 is a top view illustrating two adjacent height adjustable tables of FIG. 6. Referring to FIG. 7, the structural reinforcement member 130c disposed on the baffle 120 of the left one of the height adjustable tables 100c and the structural reinforcement member 130c of the baffle 120 of the right one of the height adjustable tables 100c may be staggered to each other. Accordingly, even if two adjacent height adjustable tables 100c are disposed too close to each other, the situation that the lifting operation of the height adjustable tabletop 111 of the height adjustable table 100c being failed due to interference between two structural reinforcement members 130c may be avoided.

To sum up, the height adjustable table of the invention includes baffles disposed on the sides of the height adjustable tabletop. Thus, even a plurality of the height adjustable tables of the invention are arranged side by side, the hand or other portion of the user abutting against the height adjustable tabletop or any article placed on the height adjustable tabletop would not be pinched during lifting operation of the height adjustable tabletop.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A height adjustable table, comprising:
a table comprising a height adjustable tabletop, wherein the height adjustable tabletop is adapted to be moved up and down in a predetermined direction; and
at least a baffle, disposed on at least a side of the height adjustable tabletop, wherein each of the baffle extends upward, downward, or upward and downward from the height adjustable tabletop, and each of the baffle comprises a maximum height along the predetermined direction no less than a maximum travel length of the height adjustable tabletop.

2. The height adjustable table according to claim 1, wherein each of the baffle extends downward from the height adjustable tabletop.

3. The height adjustable table according to claim 2, further comprising at least a structural reinforcement member, and each of the structural reinforcement member is disposed at a side of each of the baffle away from the table.

4. The height adjustable table according to claim 3, wherein each of the structural reinforcement member extends along the predetermined direction and is strip shaped.

5. The height adjustable table according to claim 3, wherein each of the baffle and the structural reinforcement member disposed thereon are integrally formed.

6. The height adjustable table according to claim 1, wherein each of the baffle extends upward from the height adjustable tabletop.

7. The height adjustable table according to claim 6, further comprising at least a structural reinforcement member, and each of the structural reinforcement member is disposed at a side of each of the baffle away from the table.

8. The height adjustable table according to claim 7, wherein each of the structural reinforcement member extends along the predetermined direction and is strip shaped.

9. The height adjustable table according to claim 7, wherein each of the baffle and the structural reinforcement member disposed thereon are integrally formed.

10. The height adjustable table according to claim 1, wherein a portion of each of the baffle extends downward from the height adjustable tabletop, another portion of each of the baffle extends upward from the height adjustable tabletop.

11. The height adjustable table according to claim 1, further comprising at least a structural reinforcement member, and each of the structural reinforcement member is disposed at a side of each of the baffle away from the table.

12. The height adjustable table according to claim 11, wherein each of the structural reinforcement member extends along the predetermined direction and is strip shaped.

13. The height adjustable table according to claim 11, wherein each of the baffle and the structural reinforcement member disposed thereon are integrally formed.

14. The height adjustable table according to claim 1, wherein the height adjustable tabletop comprises a first side, a second side opposite to the first side, and a third side connected between the first side and the second side, wherein the third side is adjacent to a user, and at least one of the baffles is disposed on the first side, the second side, or the first side and the second side.

15. The height adjustable table according to claim 1, wherein the table further comprises a plurality of height adjustable table legs supporting the height adjustable tabletop, so as to enable the height adjustable tabletop to move up and down.

16. The height adjustable table according to claim 1, wherein the baffle is comprised of metal or plastic.
